(19) United States
(12) Patent Application Publication
(10) Pub. No.: US 2008/0299895 A1
(43) Pub. Date: Dec. 4, 2008

(54) Systems and Methods for Providing Information to Exhibition Visitors

(75) Inventors: Scott A. Shamp, Athens, GA (US); Matt Griffin, Buford, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: UNIVERSITY OF GEORGIA RESEARCH FOUNDATION, INC., Athens, GA (US)

(21) Appl. No.: 12/130,319

(22) Filed: May 30, 2008

Related U.S. Application Data
(60) Provisional application No. 60/941,124, filed on May 31, 2007.

(51) Int. Cl. H04H 40/00

(52) U.S. Cl. 455/3.06

(57) ABSTRACT

In one embodiment, a system and a method for providing information to exhibition visitors pertain to a visitor of an exhibition transmitting with a mobile device a code associated with the exhibition, a server computer receiving the code from the mobile device and identifying a link to downloadable content associated with the code, the server computer sending the link to the mobile device, the visitor selecting the link on the mobile device, and the mobile device downloading content relevant to the exhibition and displaying it to the user.

### CROSS-REFERENCE TO RELATED APPLICATION

This application claims priority to copending U.S. provisional application entitled “System and Method for Obtaining Content” having Ser. No. 60/941,124 and filed May 31, 2007, which is entirely incorporated herein by reference.

### BACKGROUND

Today, visitors of exhibitions, such as museum exhibitions, are typically offered a device that enables them to receive supplemental information about the objects that are on exhibit and/or the creators of those objects. For example, it is now common at art exhibitions to make available audio devices that enable the visitors to take an “audio tour” in which they may listen to various prerecorded information about the displayed artwork. In such situations, the user normally can enter into the audio device a code associated with a given work of art and then listen to information concerning the work and the artist.

Although the above-described audio tours provide visitors with additional information about the objects they are viewing or who created them, such tours can only present the same static information to each visitor. Moreover, the amount of information that is provided as to any given object is limited. Therefore, if there is, for example, one particular work of art in which a visitor is particularly interested, the visitor will likely only be able to receive the same, relatively small amount of information about that work that he or she can receive about other works that are covered in the audio tour.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system with which information can be provided to visitor of an exhibition.

FIG. 2 is a block diagram of an embodiment of a mobile device shown in FIG. 1.

FIG. 3 is a block diagram of an embodiment of a server computer shown in FIG. 1.

FIGS. 4A and 4B comprise a flow diagram that illustrates an embodiment of a method for providing information to an exhibition visitor.

### DETAILED DESCRIPTION

As described above, the nature and amount of information that is made available to exhibition visitors is somewhat limited. As described in the following, a much greater amount of information, which the visitor can choose to review or not, can be made available to the visitor by sending to the user's mobile device (e.g., mobile phone) links to network pages that the user can download to his or her mobile device. In some embodiments, the visitor can request such links by emailing or text messaging to a server computer a code associated with a particular exhibition object about which the visitor is interested. In response, an email or text message containing an active link to a network page is sent to the mobile device that the visitor can select to download content.

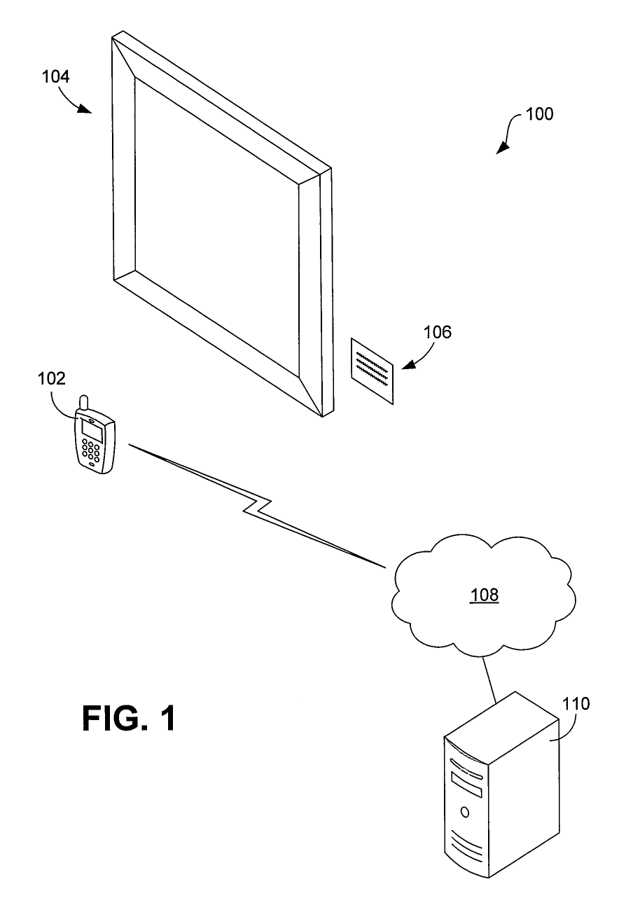

Referring to the drawings, in which like numerals identify corresponding parts throughout the several views, FIG. 1 illustrates an example system 100 that can be used to provide information to an exhibition visitor, referred to from this point forward as a “user.” As indicated in FIG. 1, the system 100 comprises a mobile device 102 of the user, which the user may generally carry with him or her. By way of example, the mobile device 102 comprises a mobile (e.g., cellular or satellite) telephone or a personal digital assistant (PDA). Irrespective of its particular configuration, the mobile device 102 has the capability to send and receive electronic messages and further comprises a network browser with which network content, such as web pages, can be downloaded and displayed.

As illustrated in FIG. 1 the user (e.g., owner) of the mobile device 102 may approach an object 104, such as a painting, that is displayed at the exhibition. Assuming that information has been made available for download regarding that object 104, a sign 106 can be displayed adjacent the object that indicates that such information exists and how to receive it. For instance, the sign 106 may post a code particular to the object 104 and an address (e.g., email address or phone number) to which the code can be sent to request a link to that information. Example codes include letters, words, numbers, or combinations thereof.

Irrespective of the nature of the transmission, the code can be sent over a network 108 to a server computer 110. The network 108 can comprise a local area network (LAN), a wide area network (WAN), a cellular network, a satellite network, or combinations thereof. Regardless, once the code is received, the server computer 110 can return content, such an active link to a network page that contains information relevant to the object 104. By way of example, the link can be emailed or text messaged back to the mobile device 102.

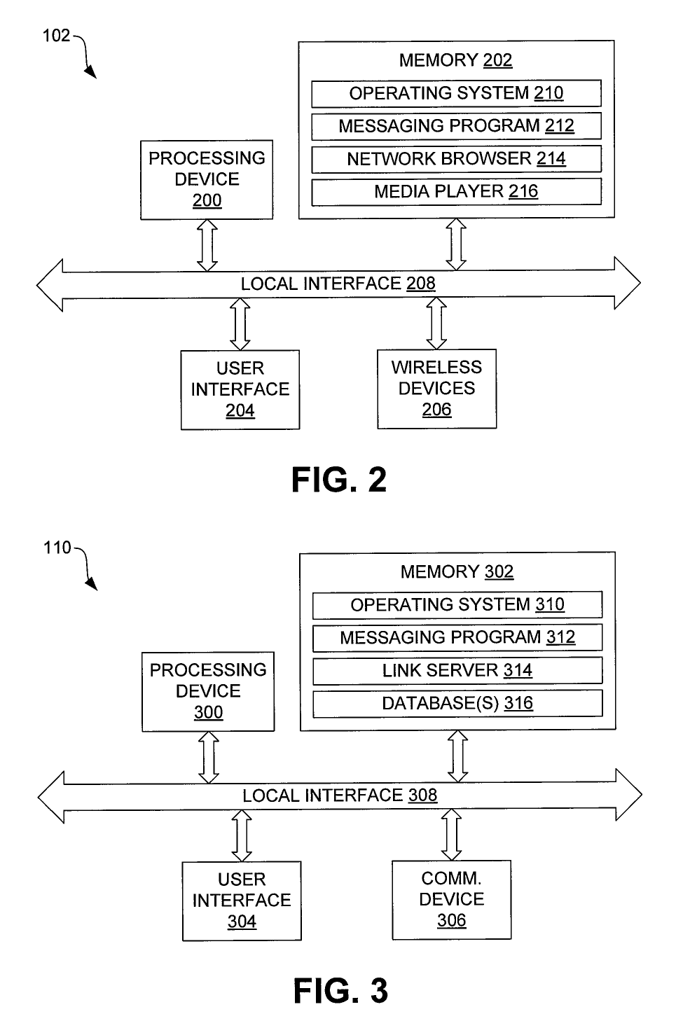

FIG. 2 is a block diagram illustrating an example architecture for the mobile device 102. As indicated in FIG. 2, the mobile device 102 includes a processing device 200, memory 202, a user interface 204, and a wireless communication device 206, each of which is connected to a local interface 208.

The processing device 200 comprises one or more processors and/or application-specific integrated circuits (ASICs) that execute commands on the mobile device 102. The memory 202 comprises one or more volatile memory elements (e.g., random access memory (RAM) elements) and/or non-volatile memory elements (e.g., flash memory elements, hard disks, etc.). The user interface 204 comprises a display and one or more input buttons, for example provided on a device keypad. The wireless communication device 206 comprise a component with which data can be wirelessly transmitted from and/or received with the mobile device 102.

The memory 202 stores various programs including an operating system 210 that controls overall operation of the mobile device 102 and a messaging program 212 that can be used to transmit and/or receive messages. In some embodiments, the messaging program 212 comprises an email program. In other embodiments, the messaging program 212 comprises a text messaging program (e.g., a short message service (SMS)) program. In addition, the memory 202 comprises a network browser 214 (e.g., web browser) that can be used to access and display network pages (e.g., web pages) served by a server computer. Furthermore, the memory 202 comprises a media player 216 that can be used to play downloaded audio and/or video content.

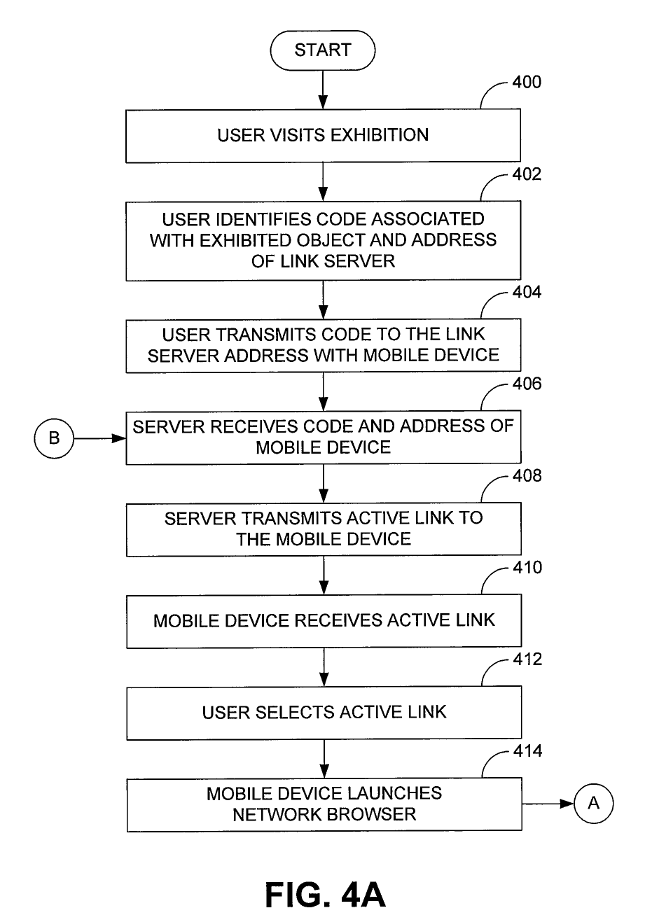

FIG. 3 is a block diagram illustrating an example architecture for the server computer 110. As indicated in FIG. 3, the server computer 110 also includes a processing device 300, memory 302, a user interface 304, and a communication device 306, each of which is connected to a local interface 38.

The processing device 300 comprises one or more processors that execute commands on the server computer 110. The memory 302 comprises one or more volatile memory elements (e.g., random access memory (RAM) elements) and/or non-volatile memory elements (e.g., flash memory elements, hard disks, etc.). The user interface 304 comprises any components with which a user (e.g., system administrator) interfaces with the server computer 110, such as a keyboard, a mouse, and a monitor. The communication device 306 comprises the components with which data can be transmitted from and/or received with the server computer 110, for example via a network.

The memory 302 stores various programs. In the embodiment of FIG. 3, the memory 302 stores an operating system 310 that controls overall operation of the server computer 110, a messaging program 312 with which links identified by a link server 314 can be sent to mobile devices of exhibition visitors, and one or more databases 316 that contain the links and content (e.g., web pages, audio data, video data) that is to be provided to the mobile devices.

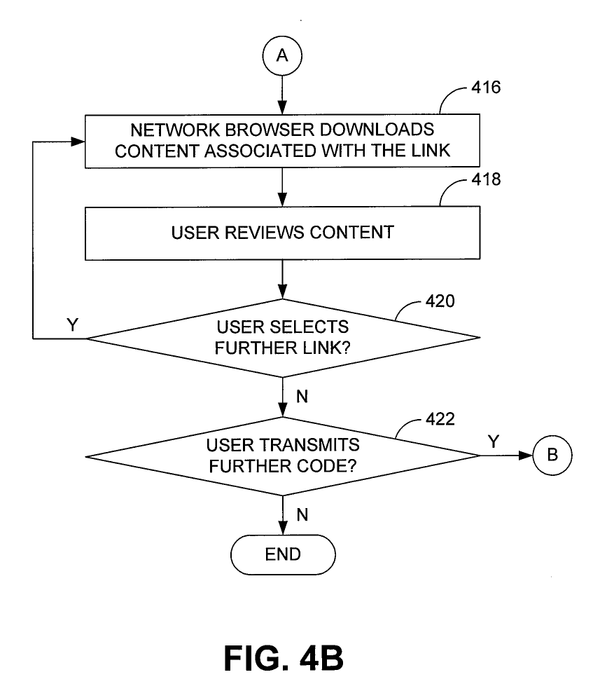

An example method for receiving information using the system 100 will now be described in relation to FIGS. 4A and 4B. Beginning with block 400 of FIG. 4A, a user visits an exhibition. By way of example, the exhibition comprises an art exhibition hosted by a museum. It is noted, however, that the described method is applicable to substantially any exhibition or other event for which additional information may be desired by an attending user.

Next, the user identifies a code associated with an object presented at the exhibition, or the exhibition in general, and an address of a server computer (e.g., computer 110) that can provide a link to such information, as indicated in block 402. By way of example, the code and address can be displayed to the user adjacent an object comprising part of the exhibition. In some embodiments, the code can comprise a textual and/or numerical code, such as an alphanumeric code. In some embodiments, the address can comprise an email address or a telephone number associated with the server computer.

Once the code and the address have been identified, the user transmits the code to the address with the user's mobile device (e.g., device 102), as indicated in block 404. By way of example, the code is transmitted to the server computer as an email or text message that contains the code in the body of the message. The server computer then receives the code and the address of the mobile device, as indicated in block 406. From the code, the server computer can determine what link or links to provide to the mobile device. In some embodiments, the links comprise active links to web pages that the user can download to his or her mobile device with a network browser of the device. Such a scenario is assumed for the remainder of the discussion. In embodiments in which the mobile device does not comprise such networking capabilities, however, the server computer can instead send static textual and/or graphical information to the mobile device.

The server computer then transmits the active link to the mobile device (block 408), and the mobile device receives the active link (block 410). By way of example, the active link comprises a web address associated with a web site hosted by the server computer (or another server computer). The user can then select the active link (block 412) so as to cause the mobile device to launch its network browser (block 414). By way of example, the mobile device launches a web browser.

Next, with reference to block 416 of FIG. 4B, the network browser downloads content associated with the link from the server computer so that the user can review the content, as indicated in block 418. The content can comprise web content in the form of one or more web pages. By way of example, a downloaded web page can comprise information about the object to which the code is associated, such as a history of the object, its meaning, opinions of experts, its impact on other works or history, and so forth. In addition, the web page can comprise one or more other active links that can be selected to browse to other web pages or other content, such as audio and/or video clips. Accordingly, if the user so chooses, the user can obtain a multitude of information about an object about which the user is interested.

Referring next to decision block 420, flow from this point depends upon whether the user selects a further link, for example a link presented in a downloaded web page. If so, flow returns to block 416 and further content is presented to the user. If not, flow continues to decision block 422 at which it is determined if the user has transmitted a further code, for example a code associated with a different object on display in the exhibition. If so, flow returns to block 406 of FIG. 4A. If not, flow for the session is terminated.

Various programs (logic) have been described herein. It is noted that those programs can be stored on any computer-readable medium for use by or in connection with any computer-related system or method. In the context of this document, a “computer-readable medium” is an electronic, magnetic, optical, or other physical device or means that contains or stores a computer program for use by or in connection with a computer-related system or method. Those programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

The following are claimed:

1. A method for providing information to exhibition visitors, the method comprising:
a visitor of an exhibition transmitting with a mobile device a code associated with the exhibition;
a server computer receiving the code from the mobile device and identifying a link to downloadable content associated with the code;
the server computer sending the link to the mobile device;
the visitor selecting the link on the mobile device; and
the mobile device downloading content relevant to the exhibition and displaying it to the user.

2. The method of claim 1, wherein transmitting a code comprises transmitting a code associated with a particular object displayed in the exhibition.

3. The method of claim 1, wherein transmitting a code comprises transmitting an email message that contains the code in a body of the message.

4. The method of claim 1, wherein transmitting a code comprises transmitting a text message that contains the code in a body of the message.

5. The method of claim 1, wherein identifying a link to downloadable content comprises identifying a link to a web page.

6. The method of claim 1, further comprising the mobile device launching a network browser that will download the content.

7. The method of claim 6, wherein launching a network browser comprises launching a web browser.

8. The method of claim 1, wherein downloading content comprises downloading a web page.

9. The method of claim 8, further comprising the user selecting a further active link presented in the downloaded web page and the mobile device downloading further content.

10. The method of claim 6, wherein displaying the downloaded content comprises presenting a web site in the network browser.

11. A computer-readable medium comprising:
logic configured to receive a code from a mobile device;
logic configured to identify an active link to downloadable content associated with the code; and
logic configured to send the active link to the mobile device to enable a user of the mobile device to download content associated with the active link.

12. The computer-readable medium of claim 11, wherein the logic configured to receive a code comprises logic configured to receive an email message that contains the code.

13. The computer-readable medium of claim 11, wherein the logic configured to receive a code comprises logic configured to receive a text message that contains the code.

14. The computer-readable medium of claim 11, wherein the logic configured to send the active link comprises logic configured to transmit an active link to a web page to the mobile device.

15. The computer-readable medium of claim 11, wherein the logic configured to send the active link comprises logic configured to transmit an email message that contains the active link in a body of the message.

16. The computer-readable medium claim 11, wherein the logic configured to send the active link comprises logic configured to transmit a text message that contains the active link in a body of the message.

17. A system comprising:
a mobile device configured to transmit a code associated with an exhibition, to receive an active link to downloadable content associated with the exhibition, and to download the content for display on the mobile device; and
a server computer configured to receive the code from the mobile device, to identify the active link to downloadable content associated with the code, and to send the active link to the mobile device.

18. The system of claim 17, wherein the active link comprises an active link to a web page.

19. The system of claim 17, wherein the mobile device is a mobile telephone or personal digital assistant (PDA).

20. The system of claim 17, wherein the mobile device is configured to transmit a text message that contains the code and wherein the server computer is configured to transmit a text message that contains the active link.
